(19) United States
(12) Patent Application Publication
(10) Pub. No.: US 2009/0000168 A1
(43) Pub. Date: Jan. 1, 2009

(54) PRINTABLE BANNERS WITH THIN-GROMMET CONSTRUCTION

(75) Inventor: Jeffrey P. CAMPBELL, Georgetown (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Cambridge Canvas Centre Ltd., Cambridge (CA)

(21) Appl. No.: 11/848,291

(22) Filed: Aug. 31, 2007

Related U.S. Application Data
(60) Provisional application No. 60/947,022, filed on Jun. 29, 2007.

(51) Int. Cl. G09F 17/00

(52) U.S. Cl. 40/604

(57) ABSTRACT

Printed grommeted banners are produced by applying thin grommets to banner material prior to introduction to a printing device, the grommets being sufficiently thin to permit feeding into the printing device. The grommets have a top flange and a barrel portion extending downwardly from the top flange, the barrel portion being crushed against the top flange to capture banner material between the crushed barrel portion and the top flange, the grommet and banner material having a combined thickness not exceeding 0.075 inches when so crushed. Preferably, the grommet captures a double layer of the banner material, and the grommet and banner material have a combined thickness in the range of 0.045-0.075 inches, 0.054 inches being a specific example. Alternatively, the grommet may capture only a single layer of material and the grommet and banner material may have a combined thickness in the range of 0.025-0.035 inches.

### REFERENCE TO RELATED APPLICATION

This is a formal application based on and claiming the benefit of provisional application Ser. No. 60/947,022, filed Jun. 29, 2007.

### BACKGROUND OF THE INVENTION

### Field of the Invention

This invention relates to the sign industry. It provides the sign industry with the ability to easily print a ready-made banner product.

To the best of the inventor's knowledge, no-one at this point can print a banner with grommets already attached. The production process presently requires the banner material to be printed, and then it must be “finished”. The finishing process typically requires the sign maker to (a) square the material, (b) possibly hem the edges with hem tape, and (c) measure, mark and then grommet the material using typically a hand-operated grommet machine. Sign makers do not like this process, and may not be well equipped to carry it out efficiently, cost-effectively or with adequate quality.

There is accordingly a need for a system which permits banners to be in effect pre-finished, i.e. grommeted before printing, so that sign makers can simply print the banners and not have to be involved in grommeting nor in maintaining a grommeting machine nor an inventory of grommeting supplies such as grommets, hem tape, etc., or so that they can avoid sending out the printed banners to subcontractors for finishing (which is time consuming).

### SUMMARY OF THE INVENTION

In view of the preceding, it is an object of the invention to provide a banner which is grommeted prior to printing. This requires that the banner material be provided with very thin grommets which are capable of being fed through conventional printing devices, e.g. printers or plotters. Conventional plotters typically will not accommodate thicknesses of more than about 0.055 inches or in some cases 0.065 inches. Accordingly, the invention provides a very thin grommet in combination with the banner material, permitting the grommeted banner material to be fed through a printing device. No washer is used.

More specifically, the invention provides printable banner material having thin grommets applied thereto prior to introduction to a printing device, the grommets being sufficiently thin to permit feeding into the printing device. The grommets have a top flange and a barrel portion extending downwardly from the top flange. The barrel portion is crushed against the top flange to capture banner material between the crushed barrel portion and the top flange, the grommet and the banner material having a combined thickness not exceeding 0.075 inches when so crushed.

Preferably, the grommet captures a double layer of the banner material, and the grommet and banner material have a combined thickness in the range of 0.045-0.075 inches, 0.054 inches being a specific example. Alternatively, the grommet may capture only a single layer of material and the grommet and banner material may have a combined thickness in the range of 0.025-0.035 inches.

Preferably but not essentially, the banner material may be provided on a roll, with spaced-apart grommets pre-installed, so that banners may be printed and then simply cut from the roll. Preferably, but again not necessarily, the grommets may be arranged as in commonly-owned U.S. Pat. No. 6,495,238 (Campbell).

In its preferred embodiment, the invention thus provides sign companies with the ability to print images onto what is essentially a ready-made banner that can be pulled off the roll, printed, cut, and then boxed and shipped with no finishing stage required.

Further details of the invention will be described or will become apparent in the course of the following detailed description and drawings of specific embodiments of the invention, as examples.

### BRIEF DESCRIPTION OF THE DRAWINGS

Embodiments of the invention will now be described, by way of example only, with reference to the attached drawings, in which:

FIG. 1 is an illustration of the preferred embodiment of a banner, shown exiting a plotter;

FIG. 2 is a perspective view of a typical grommet according to the invention;

FIG. 3 is a cross-section of the grommet;

FIG. 4 is a perspective view of a typical die arrangement used to crush the grommet onto the banner material;

FIG. 5 is a perspective view of a grommet, showing one alternative notch configuration;

FIGS. 6A-6C are bottom views showing alternative grommet configurations;

FIGS. 7A-7C are bottom views showing convex grommet tabs;

FIG. 8A is a cross-section showing a grommet inserted into a hole in the banner material;

FIG. 8B is a corresponding view after crushing of the grommet;

FIG. 9 is a view of the grommeted banner material, showing grommet locations and the printable area; and

FIG. 10 is a view similar to FIG. 9, showing alternative grommet locations;

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

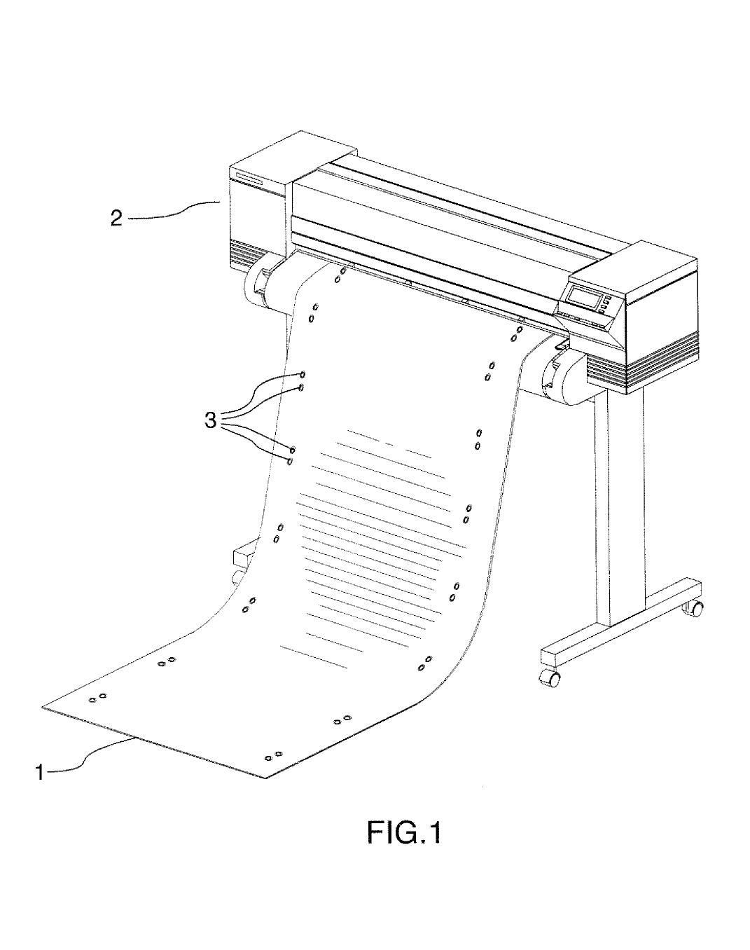

FIG. 1 shows the preferred embodiment of a banner 1 leaving a typical plotter 2. The banner material has been pre-finished with grommets 3. The banner material preferably is fed into the printer from a roll of material (not shown), though individual lengths of banner material could be used if desired, whether supplied in that form, or cut from a roll before printing. The grommets are not conventional, available grommets; they are originally designed by the inventor for this invention.

In FIG. 1, the spacing of the grommets is as in commonly-owned U.S. Pat. No. 6,495,238 (Campbell), i.e. with pairs of closely-spaced grommets so that a finished banner can be produced by cutting between the closely-spaced grommets with minimum waste of banner material, as explained in that patent. However, this spacing of the grommets is not essential to this invention, though advantageous as explained in the prior patent.

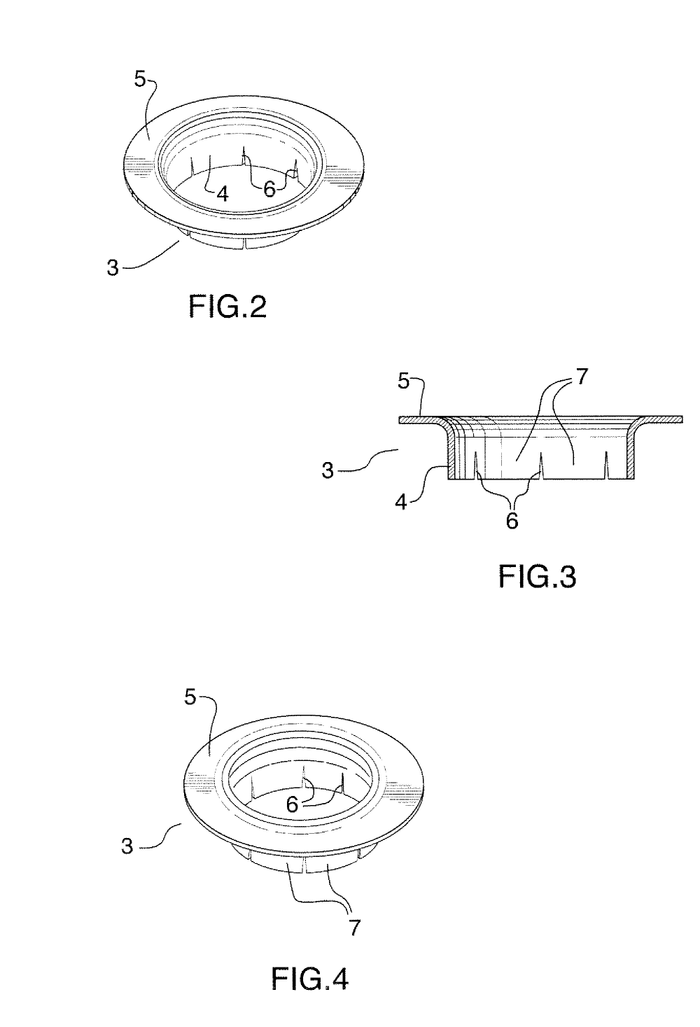

FIG. 2 is a perspective view of a grommet 3 according to the invention, and FIG. 3 is a cross-section thereof. In the invention, this is a one-piece grommet, i.e. there is no separate washer. This allows the grommet to be crushed to a much thinner thickness than is conventional, and also results in a much flatter overall grommet.

In the grommet of FIGS. 2 and 3, the barrel 4 has eight notches 6 extending upwardly from the bottom edge resulting in eight tabs 7 for crushing onto the banner material. The notches may extend only a short distance up the barrel as shown, or may extend higher up, as shown in FIG. 4.

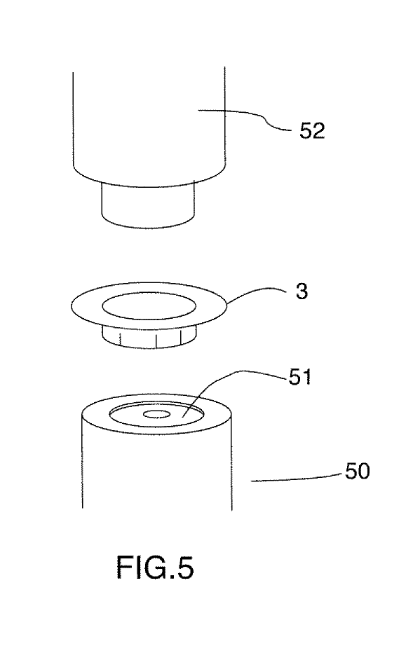

FIG. 5 shows a typical die arrangement used to crush the grommet onto the banner material, the die having a base 50 with a recess 51 and an upper element 52 for crushing the grommet into the recess in the base. The specific die configuration is not part of the invention as such. The banner material itself is not shown in this view. Preferably but not necessarily, the banner material is pre-punched with a hole at the grommet location, and preferably that hole is slightly smaller than the diameter of the barrel 4 of the grommet. This produces a slight bunching of the material under the top flange 5 of the grommet when crushed, not sufficient to increase the overall thickness of the grommet to any significant degree, but sufficient to slightly improve the strength and securing of the grommet to the material. It should be appreciated, however, that it is not strictly necessary that any hole be pre-punched, since the grommeting operation can itself be relied on to produce the hole if desired.

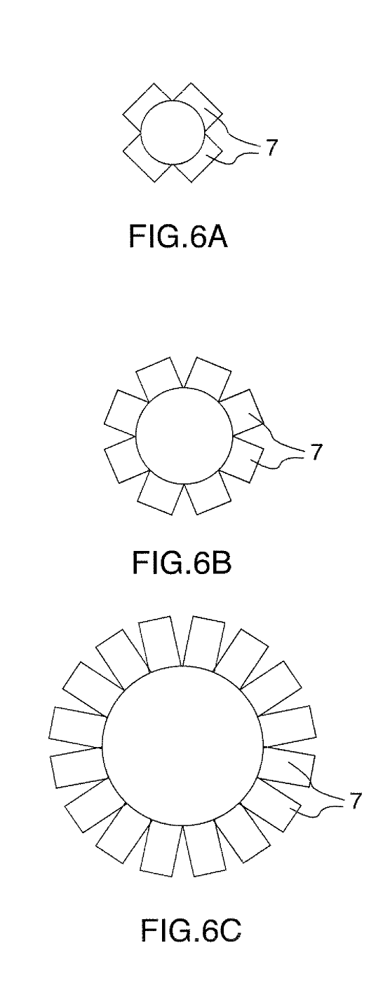

Furthermore, as shown in FIGS. 6A-6C, there may be any desired number of such notches 6. FIGS. 6A to 6C show four, eight and sixteen notches respectively. There is no reason why other numbers of notches could not be used if desired.

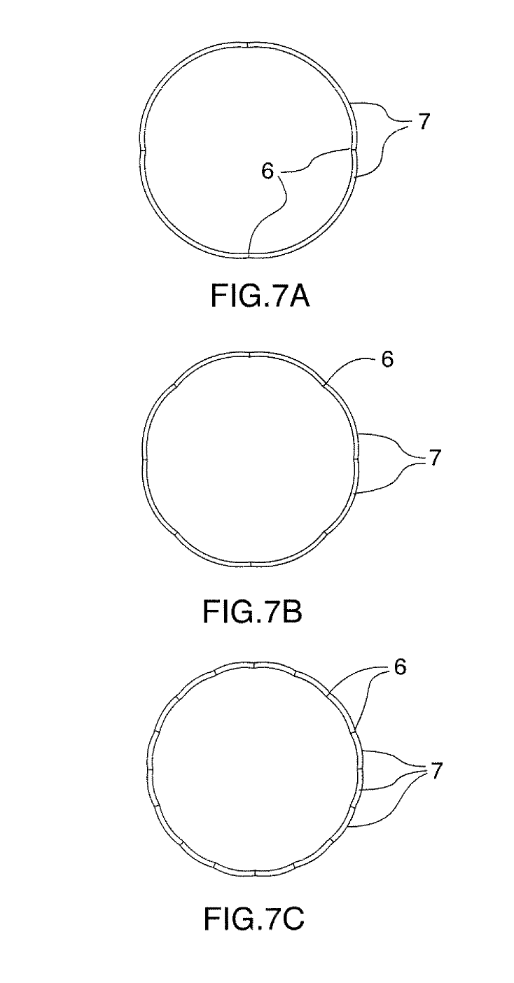

Preferably, and for simplicity, the barrel is cylindrical or generally cylindrical. However, that is not necessarily the case. It could be, for example, hexagonal, with or without notches at each corner of the hexagon, and with or without notches elsewhere. For example, there could be a generally hexagonal shape, with twelve notches. A wide variety of other shapes could be adopted for the barrel, and the invention is not restricted to any particular shape. Nor do the tabs need to be follow the overall profile of the barrel; they could be slightly convex or concave, for example. FIGS. 7A-7C show convex tabs 7 for example, there being four, eight and sixteen such tabs respectively.

It should also be appreciated that a wide range of grommet diameters could be used, according to the application and user preference. Large banners may require large grommets, for example, to accommodate large ropes for hanging, whereas small grommets may suffice for small banners. Some typical examples are a ⅝ inch diameter top flange 5 with a ⅜ inch diameter hole size (essentially the internal diameter of the barrel 4); ½ inch flange with 19/64 inch hole; ⅜ inch flange with 15/64 inch hole; 5/16 inch flange with 3/16 inch hole; and ¼ inch flange with 5/32 inch hole. Respective barrel depths for these five examples may be ⅛ inch, 3/32 inch, 5/64 inch, 1/16 inch and 3/64 inch. However, it should be recognized that these dimensions may be readily varied as desired, within the overall thickness parameters of the invention.

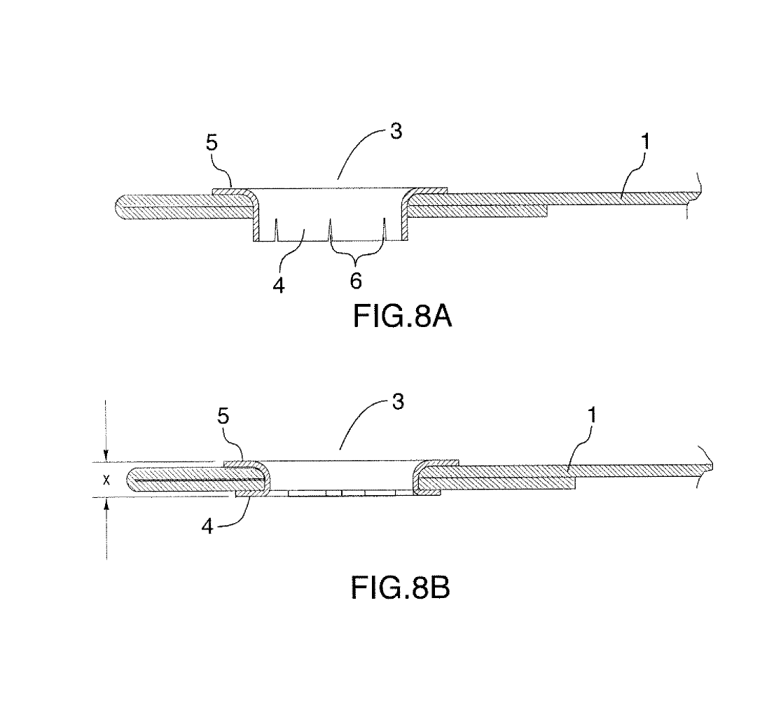

FIG. 8A is a cross-section showing a grommet 3 inserted into a hole in the banner material 1 prior to crushing. In this case, as is preferred for strength, there are two layers of the banner material, i.e. the edge has been folded over to form a hem 8 (typically secured by a heat weld). However, it should be clearly understood that there could be only a single layer. In some cases, more than two layers could be used, but caution would have to be employed to keep the overall thickness within the range which is acceptable for the particular printer or plotter.

FIG. 8B is a corresponding view after crushing of the grommet. It should be noted that due to the washerless nature of this grommet, a very thin overall thickness is achieved compared to the prior art of this industry.

More specifically in terms of dimensions, the preferred thickness of the grommet material is 0.010 inches, or in the range of 0.008-0.015 inches. The combination of the crushed grommet and banner material has a maximum thickness X (see FIG. 8B) in the range of 0.045-0.075 inches for a double material layer, i.e. with a hem, and 0.025-0.035 inches for a single material layer. A specific example of a total double layer thickness achieved by the invention is 0.054 inches.

Since typical plotters may accept thicknesses up to about 0.055 inches, the invention permits even a double layer to be used, at least at the lower end of the above-stated 0.045-0.075 inch range. Some newer plotters, especially those which are height-adjustable, will accept up to 0.065 inches thickness, which the invention can accommodate even more easily, even with a double layer. Future plotters may accommodate even the full range up to 0.075 or perhaps greater. Conventional grommets result in a typical overall thickness of approximately 0.085 inches, which even the latest plotters known to the inventor cannot accommodate.

It should be clearly understood that these dimensions are examples only and that other sizes could be used, depending on the thickness permitted or accepted by the particular printer.

A typical banner material, as in the preferred embodiment, is between 8-ounce and 18-ounce PVC coated or laminated vinyl material having a thickness of typically 0.010 to 0.015 inches. Of course other materials and thicknesses could be used, within the parameters of the maximum overall grommet and material thickness called for by the invention.

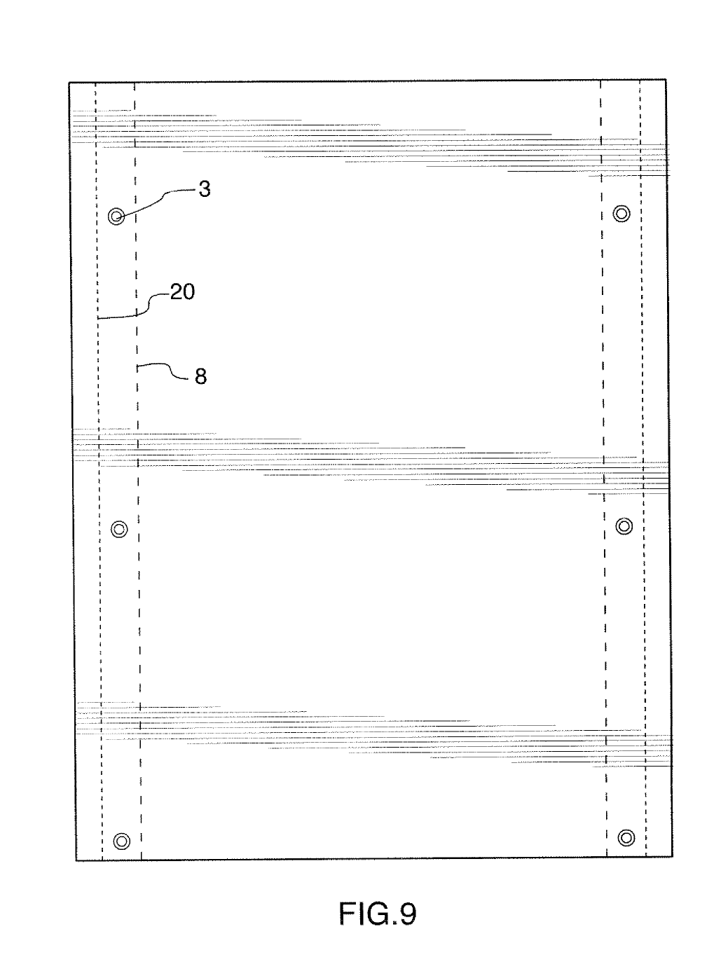

FIG. 9 shows the grommeted banner material, to illustrate another advantage of the invention. Note the amount of material between the grommets and the outer edges of the banner. In a typical plotter, it is not possible to print right out to the edge of the material. A drive roller runs along the outer edge, and the printable area stops at the dotted line 20. In this drawing, a second dotted line indicates the location of the optional hem 8, i.e. if the banner material has been folded under to create a double layer for grommeting. The illustrated configuration allows the banner to be printed out to the dotted line 20, and subsequently trimmed to that line, leaving a grommeted banner which is completely printed, i.e. with no unprinted border.

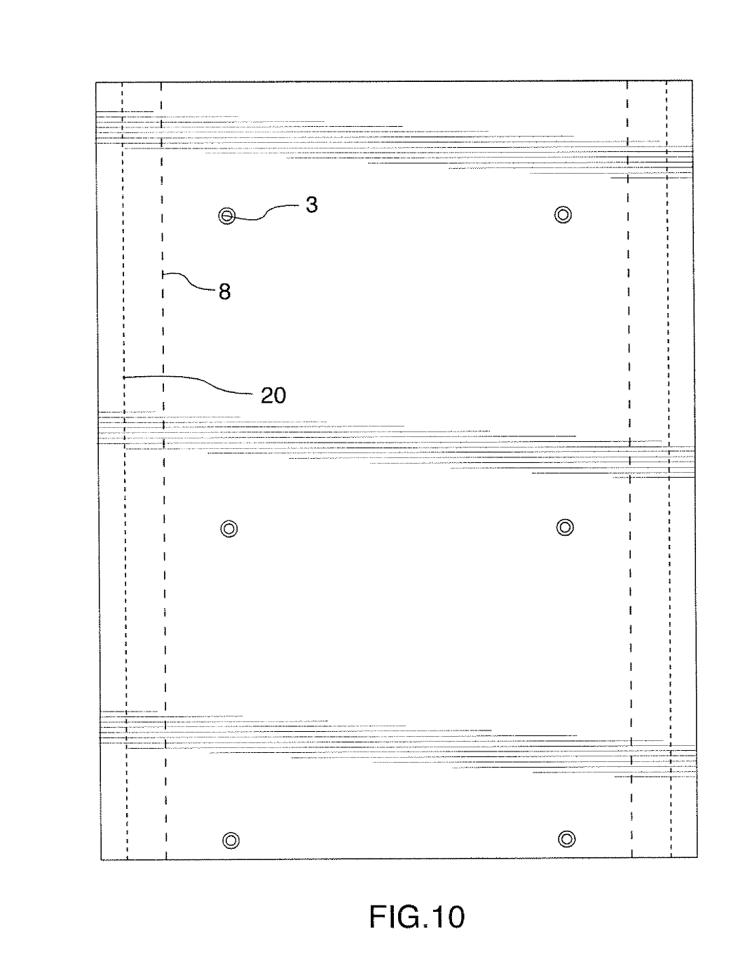

FIG. 10 is intended simply to illustrate that the grommets 3 may be located well inside the hem 8, up to four inches for example, if desired for some reason and if permitted by the particular plotter configuration.

It will be appreciated that many further variations are possible within the scope of the invention as defined by the following claims, and will be apparent to those knowledgeable in the field of the invention.

1. Printable banner material having thin grommets applied thereto prior to introduction to a printing device, the grommets being sufficiently thin to permit feeding into the printing device, said grommets having a top flange and a barrel portion extending downwardly from said top flange, said barrel portion being crushed against said top flange to capture banner material between said crushed barrel portion and said top flange, said grommet and said banner material having a combined thickness not exceeding 0.075 inches when so crushed.

2. Printable banner material as in claim 1, wherein said grommet captures a double layer of said banner material, and wherein said grommet and said banner material have a combined thickness in the range of 0.045-0.075 inches.

3. Printable banner material as in claim 2, wherein said grommet and said banner material have a combined thickness of approximately 0.054 inches.

4. Printable banner material as in claim 1, wherein said grommet captures a single layer of said banner material, and wherein said grommet and said banner material have a combined thickness in the range of 0.025-0.035 inches.

5. Printable banner material as in claim 1, wherein said barrel portion of each said grommet has a plurality of notches extending from a lower end thereof towards said top flange.

6. A method of producing printed grommeted banners, comprising the step of applying thin grommets to banner material prior to introduction to a printing device, the grommets being sufficiently thin to permit feeding into the printing device, said grommets having a top flange and a barrel portion extending downwardly from said top flange, said barrel portion being crushed against said top flange to capture banner material between said crushed barrel portion and said top flange, said grommet and said banner material having a combined thickness not exceeding 0.075 inches when so crushed.
